(19) United States
(12) Patent Application Publication
(10) Pub. No.: US 2018/0284731 A1
(43) Pub. Date: Oct. 4, 2018

(54) Apparatus for Generating at least one Identifier of at least one Article

(71) Applicant: Robert Bosch GmbH, Stuttgart (DE)

(72) Inventors: Florian Esenwein, Leinfelden-Echterdingen (DE); Joachim Schadow, Stuttgart (DE); Joern Stock, Leinfelden-Echterdingen (DE)

(21) Appl. No.: 15/938,968

(22) Filed: Mar. 28, 2018

(30) Foreign Application Priority Data
Mar. 29, 2017 (DE) 10 2017 205 299.6

(51) Int. Cl. G05B 19/418; B25F 5/00

(52) U.S. Cl. CPC G05B 19/4183; G05B 2219/45127; B25F 5/00; G05B 19/4185

(57) ABSTRACT

An apparatus for generating at least one identifier of at least one article, in particular a machine tool, includes at least one sensing unit that senses at least one usage parameter and/or at least one article parameter of the article. The apparatus includes at least one computing unit that takes the at least one sensed usage parameter and/or the at least one sensed article parameter as a basis for issuing a certificate for the article.

This application claims priority under 35 U.S.C. § 119 to patent application no. DE 10 2017 205 299.6, filed on Mar. 29, 2017 in Germany, the disclosure of which is incorporated herein by reference in its entirety.

### BACKGROUND

An apparatus for generating at least one identifier of at least one article has already been proposed, having at least one sensing unit that senses at least one usage parameter and/or at least one article parameter of the article.

### SUMMARY

The disclosure proceeds from an apparatus for generating at least one identifier of at least one article, in particular a machine tool, having at least one sensing unit that senses at least one usage parameter and/or at least one article parameter of the article.

It is proposed that the apparatus has at least one computing unit that takes the at least one sensed usage parameter and/or the at least one sensed article parameter as a basis for issuing a certificate for the article and/or in particular assigning the article to at least one person.

The apparatus design according to the disclosure makes it possible to improve the efficiency of management of the article. As a further advantage, the at least one article parameter and/or the at least one usage parameter can be specifically stored, conditioned and/or combined by means of the certificate. In particular, a data record specific to a service, such as maintenance, for example, can easily be read using the certificate. This in particular allows services, such as maintenance, repair, rental or the like, for example, to be improved. Further, it is advantageously possible for a transmission of parameters of different parameter types to be simplified. As a further advantage, user convenience can be improved by virtue of registration being able to be simplified and/or a warranty for the article being able to be made possible, in particular when a proof of purchase has been lost. In particular, the certificate can be used to match a warranty to a state, in particular a state of wear, in particular an operating time, of the article. Further, a wear on the article can be taken as a basis for allowing a user an option to extend a warranty for the article. As a particular advantage, monitoring of the article during the life thereof can be improved, with production, distribution and/or warehousing of the article, maintenance, change of ownership and/or the like being taken into consideration. As a further advantage, product security can be improved, since the certificate can be used to certify an authenticity of the article, which advantageously allows distinction of counterfeits to be improved. As a particular preference, the assignment allows an activity of the person, and further articles assigned to the person, to be taken into consideration during servicing and/or repair, so that it is in particular possible to avoid simultaneous servicing of the articles, in particular in one area of application.

An “identifier” is supposed to be understood to mean, in particular, a link that is characteristic of an article and that, in particular, is intended for processing in the computing unit. In particular, the identifier is intended to link the article to the certificate and/or to the person. The identifier may in particular be a digital identifier, such as an identification code that is in particular intended for registering the article in a stock of articles, for example. “Intended” is in particular supposed to be understood to mean specifically programmed, designed and/or equipped. An object being intended for a particular function is in particular supposed to be understood to mean that the object performs and/or executes this particular function in at least one application state and/or operating state. By way of example, the computing unit and/or the sensing unit is/are intended for a function described here. An “article” is in particular supposed to be understood to mean an object that is intended at least for executing at least one function and that, in particular for executing the function, is preferably at least guidable and/or portable by a person. The article is in particular a tool, preferably a hand-held tool. As a particular preference, the article is an in particular electrically operated and preferably portable machine tool, preferably a hand-held machine tool. A “portable machine tool” is in particular supposed to be understood here to mean a machine tool for machining workpieces that can be transported by an operator without a transport machine. The portable machine tool has in particular a mass of less than 40 kg, preferably less than 10 kg and particularly preferably less than 5 kg. A “hand-held machine tool” is in particular supposed to be understood to mean a workpiece-machining machine, but advantageously a drilling machine, a hammer drill and/or demolition hammer, a saw, a plane, a screwdriver, a router, a sander, an angle grinder, a garden implement, such as a lawnmower, for example, and/or a multifunction tool. Alternatively, the article may also be an item of work clothing, such as a safety jacket, for example, or an electronic work appliance, such as a smartphone, for example. As a particular preference, at least part of the apparatus is part of the article. Further, the article can comprise the apparatus completely. Alternatively, the apparatus may be configured to be at least partly, preferably at least largely and particularly preferably completely separate from the article and may preferably be part of an external unit.

A “sensing unit” is in particular supposed to be understood to mean a unit that has at least one sensor for sensing the at least one usage parameter and/or the at least one article parameter. The sensing unit is preferably intended to sense multiple usage parameters and/or multiple article parameters and, to that end, can comprise multiple sensors. The sensing unit is in particular part of the article. Alternatively, the sensing unit may be configured to be separate from the article and may preferably be part of an external unit. The sensing unit and/or in particular a sensor group of the sensing unit comprises, in particular as a sensor, at least one photosensor, preferably a CCD (Charge-Coupled Device) sensor, at least one force sensor, at least one pressure sensor, at least one acceleration sensor, in particular at least one Hall sensor, at least one position sensor, in particular at least one GPS (Global Positioning System) sensor, at least one current sensor, at least one voltage sensor, at least one resistance sensor, at least one power sensor, at least one energy sensor, at least one vibration sensor, at least one oscillation sensor, at least one sound pressure sensor, in particular at least one piezo sensor, at least one distance sensor, in particular at least one laser and/or infrared sensor, at least one humidity sensor and/or the like. In particular, it is conceivable that different sensing units and/or different sensors and/or sensor groups, in particular of one and the same sensing unit, are intended to sense different parameters and/or characteristic quantities. The external unit may in particular be a mobile, in particular electrical, unit, such as a wearable, a laptop, a tablet, a smartphone, a smartwatch or the like, for example, and also in particular a sensor module and/or a communication module. Alternatively, the external unit may be part of a company headquarters, of a network, in particular of a computer network, of a server, in particular of a server network, preferably of a cloud. A “usage parameter” is in particular supposed to be understood to mean a characteristic value that maps a usage of the article and/or that is at least indirectly, preferably directly, correlated to usage of the article. The usage parameter may in particular be configured an internal usage parameter determined in particular by an article-internal sensing unit. Alternatively, the usage parameter may in particular be an external usage parameter determined in particular by an article-external sensing unit, be configured. Preferably, the usage parameter is a usage time, a usage duration, a number of usages, a usage location, a usage intensity, in particular a usage load, preferably a usage wear and tear, and/or a usage state of the article. Further, the usage parameter could be a parameter of a usage routine performable on initial startup. A usage routine may in particular comprise a particular sequence of functions, key combinations or the like. In particular, at least two, preferably a plurality, of these usage parameters, in particular of different parameter types, are used for issuance of the certificate and/or for assignment of the article to a person. The usage parameter can in particular be ascertained from at least one appliance characteristic value, such as, for example, from a current, a voltage, a rotation speed, an acceleration, in particular a vibration, a power, an orientation, a number of switch-on operations, a number of switch-off operations, an article-internal operating time, a wear on parts, a switching time, a rotation speed behavior, a temperature and/or the like, and also in particular from triggering of at least one safety function, such as a kickback, for example. By way of example, the respective number of switch-on operations, number of switch-off operations and/or the article-internal operating time can be used to generate the usage duration. Further, it is conceivable for the usage parameter to be able to be a usage wear and tear. This could be determined using the usage duration and a wear, for example. The usage time may in particular be a time of first operation. The usage duration may in particular be a duration, in particular a total usage duration of components and/or parts and/or of the whole hand-held machine tool and/or of the work clothing, such as, for example, at least one motor, in particular at least one direction of operation of the motor, at least one electronics unit, at least one tool, such as, for example, at least one screwdriver, at least one drill, at least one chisel or the like, at least one energy store, such as at least one storage battery and/or at least one battery, for example, in fact the usage duration may preferably be at least one charging duration and/or at least one discharge duration, at least one overload operating duration or the like. Further, the number of usages may in particular be a number of switch-on and/or switch-off processes, a number of charging and/or discharge cycles of an energy store, a number of triggered inverter circuits of an electronics unit and/or of a motor, a number of usages of tools, a number of triggered protection functions, such as a kickback, a restart and/or a reset, for example, a number of erroneous usages, for example as a result of drops and/or improper storage, or a number of error messages. The usage intensity is, in particular, a preferably average, percentage and/or maximum power of the hand-held machine tool and/or of the work clothing, at least one current intensity, at least one voltage intensity, at least one phase shift between current and voltage and/or at least one preferably average and/or maximum rotation speed or change of rotation speed and/or an overload. Further, the usage intensity may be at least one oscillation intensity, at least one vibration intensity, at least one sound emission intensity, at least one preferably average, percentage and/or maximum torque, at least one preferably average, percentage and/or maximum efficiency, at least one contact-pressure force, in particular at least one contact-pressure force intensity and/or an impact energy. The usage temperature is in particular an average, percentage and preferably maximum temperature, preferably a temperature gradient, in fact in particular before, after and/or during operation of the hand-held machine tool and/or the work clothing, in fact in particular of the motor, of the energy store, of the tool, such as a drill, screwdriver and/or chisel, for example, or of an accessory and/or of an environment of the hand-held machine tool and/or of the work clothing. The usage state is in particular a state of the hand-held machine tool and/or of the work clothing, such as, by way of example, an error state, an idle state, a working state, a state of charge of the energy store and/or a state of derating of at least one electrical component of the hand-held machine tool and/or of the work clothing, such as, for example, an electronics unit, the energy store and/or a motor. The usage wear and tear is in particular an alteration, over time, in at least one part of the hand-held machine tool and/or in the work clothing, in fact in particular of a tool and/or of an electrical component, such as, for example, an internal resistance of the energy store, a charging and/or discharge curve of the energy store and/or a derating curve.

An “article parameter” is in particular supposed to mean a location, a completion time, a production parameter, a maintenance parameter, such as in particular a maintenance time and/or an indication of a component to be maintained in the article, and/or a distribution parameter. The article parameter may in particular be configured an internal article parameter determined in particular by an article-internal sensing unit. Alternatively, the article parameter may in particular be configured as an external article parameter determined in particular by an article-external sensing unit. A “distribution parameter” is in particular supposed to be understood to mean a characteristic value that characterizes a distribution, such as in particular a sale and/or a rental, of the article and/or that is correlated thereto, such as in particular a purchase time, preferably a purchase date, a proof of purchase, a piece of vendor information, such as preferably a sales location, a piece of owner information, a piece of previous owner information, a rental time, preferably a rental date, a rental slip, a piece of rental information, such as preferably a rental location or a piece of renter information, or the like. A “production parameter” is in particular supposed to be understood to mean a characteristic value that characterizes production of the article and/or is correlated thereto, such as in particular a serial number, a production time, preferably a production date, a piece of production information, such as preferably a production location, or the like. The apparatus in particular has at least one memory unit for retrievably storing the parameters and/or the certificate. The memory unit can in particular have at least two, preferably multiple, different memory partitions that are intended for storing different parameters, in particular different parameters assigned to a respective certificate, and/or certificates. In particular, the memory unit is configured as part of the article, in fact preferably as a memory chip, such as, for example, a SIM card, and/or as a GSM card and/or as part of an article electronics unit, an external electronics unit or the like. Alternatively, the memory unit may be configured to be at least partly, preferably at least largely and particularly preferably completely separate from the article and may preferably be part of an external unit. A “computing unit” is in particular supposed to be understood to mean a unit having a preferably wireless information input, an information processing system and an information output. Advantageously, the computing unit has at least one processor, a memory, input and output means, further electrical components, an operating program, closed-loop control routines, open-loop control routines and/or computation routines. In particular, the computing unit stores a method for generating the identifier of the article. Preferably, the components of the computing unit are arranged on a common circuit board and/or advantageously arranged in a common housing. The computing unit is in particular part of the article. Alternatively, the computing unit may be configured to be separate from the article and may preferably be part of an external unit.

A “certificate” is in particular supposed to be understood to mean an identifier that characterizes the article and that in particular comprises properties of the article and/or information associated with the article. Preferably, the certificate combines at least one usage parameter and/or article parameter, preferably at least two usage parameters and/or article parameters and particularly preferably at least two different parameter types, such as in particular at least one usage parameter and at least one article parameter. Further, it is conceivable for at least one certificate and at least one further certificate to be able to be combined to produce at least one main certificate. Alternatively or additionally, the certificate has at least one assigned authorization parameter and/or encryption parameter. The authorization parameter in particular comprises an authorization for storage, changing and/or retrieval of the certificate. The encryption parameter in particular comprises at least one key for encrypting and/or decrypting the certificate. One design of the certificate is in particular dependent on a combination of the at least one article parameter and/or the at least one usage parameter by means of which the certificate is issued. Preferably, the certificate is an operation certificate, an authenticity certificate and/or preferably a replacement certificate that is intended to add to and/or replace a warranty certificate, such as, for example, a proof of purchase, a warranty document or the like for the article at least temporarily or completely. Further, it is conceivable for the certificate to be configured as a production certificate that in particular combines at least parameters of a production, as at least one test certificate that combines at least parameters of a usage intensity, as at least one registration certificate that combines parameters of an identity of the article and/or of a person assigned to the article, as at least one first operation certificate that in particular combines parameters of a first operation, as at least one maintenance certificate that in particular combines parameters of a maintenance of the article, as at least one safety certificate that combines parameters of an operational safety of the article, as at least one life certificate that in particular combines parameters of a usage duration, and/or as at least one disposal certificate. It is conceivable for use of the replacement certificate to result in a standard proof of purchase or warranty document being able to be dispensed with completely. Alternatively or additionally, the certificate could be intended for, in particular cashless, purchase of the article, of accessories and/or for booking servicing work, such as, for example, maintenance, servicing and/or repair, or the like, in particular in electronic trading, such as in particular via an online portal, Internet trading, E-commerce or the like, and could advantageously be used therein as a digital proof of purchase. By way of example, the certificate may be configured as a card number of a SIM (Subscriber Identity Module) card and/or GSM (Global System for Mobile Communications) card, in particular integrated in the article, as an MAC address and/or as an IMEI (International Mobile Station Equipment Identity) number stored in a memory unit of the article.

It is further proposed that the computing unit at least uses the at least one usage parameter and/or the at least one article parameter to ascertain at least one time of first operation of the article and issues the certificate on the basis thereof. A “time of first operation” is in particular supposed to be understood to mean a time of first operation of an article by an end customer. The first operation is in particular different than a test operation, which can be performed during production and/or during distribution, for example. The first operation can, by way of example, be detected when the usage parameter exceeds a usage limit value, from which point onward a first operation is assumed. The limit value is in this case set such that the usage parameter does not exceed the limit value in a test operation. If the usage parameter is a usage duration, for example, the computing unit establishes first operation in the event of a usage limit value, in particular a usage limit duration, being exceeded. Preferably, the computing unit uses a further usage parameter, such as, for example, a usage time, to determine the time of first operation. Particularly advantageously, the computing unit at least uses the time of first operation to issue a first operation certificate for the article. It is advantageously possible for detection of a first operation to be improved. In particular, it is possible to prevent a test operation, such as during production and/or distribution of the article, for example, from being confused with a first operation. As a further advantage, a time of first operation that is different than a purchase time can be taken into consideration when issuing the replacement certificate, which means that it is in particular possible for a warranty to be extended. Advantageously, the time of first operation can replace a purchase time when the replacement certificate is issued. As a particular preference, a usage-adapted warranty can be provided that in particular extends beyond a legal guarantee.

Moreover, it is proposed that the computing unit uses at least one distribution parameter and/or production parameter stored in an in particular internal memory unit to verify the ascertained time of first operation. The memory unit may in particular be a memory unit of the apparatus. Preferably, the memory unit is an in particular internal memory unit of the article. The memory unit may alternatively be configured to be different than and/or separate from the article. In particular, the memory unit may be part of an external unit. It is conceivable for the memory unit to be part of the computing unit. It is conceivable for the sensing unit to sense the distribution parameter and/or the production parameter and store it/them in particular in the memory unit. Preferably during production and/or during distribution, in particular during sale and/or loan, of the article, the distribution parameter and/or the production parameter is/are stored in the memory unit. In particular, it is conceivable for the distribution parameter and/or the production parameter to be able to be stored in the memory unit by a user to verify the time of first operation. It is advantageously possible for a time of first operation to be taken into consideration when the replacement certificate is issued. As a further advantage, erroneous determination of a time of first operation can be avoided. As a particular advantage, misuse as a result of manipulation of distribution parameters and/or production parameters can be avoided.

Additionally, it is proposed that the computing unit uses the at least one distribution parameter and/or the at least one production parameter and the ascertained time of first operation to compute an age of the article and issues the certificate on the basis thereof. In particular, the computing unit can use the usage parameter to determine a usage period computed from the difference between the age of the article and the period between the purchase time and a respective usage time, in particular a time of first operation, and to take said usage period into consideration when issuing the certificate. As a particular preference, the time of first operation replaces a purchase time, in particular within the framework of a warranty, if the purchase time differs significantly from the time of first operation. The time of first operation “differing significantly from the purchase time” is in particular supposed to be understood to mean that the purchase time and the time of first operation are at least five hours, preferably at least fifteen hours and particularly preferably at least thirty hours, apart. In particular, the computing unit, when determining an interval of time between time of first operation and purchase time, weights the latter using an article-specific correction factor that is dependent on an average period of use of the article in particular per day. In particular, the correlation factor comprises a value of one hour per day and particularly preferably of half an hour per day. It is advantageously possible for a certificate to be issued that can exclude periods, such as of transport and/or storage, for example, from a warranty time, which means that a total warranty time can be extended.

It is further proposed that the computing unit at least uses the at least one usage parameter and/or the at least one article parameter to ascertain at least one application of the article and issues the certificate on the basis thereof. In particular, the computing unit can adapt the certificate, in particular a life certificate, for a changing application over the course of a life of the article. In particular, the computing unit can ascertain a main application of the article. A “main application” is in particular supposed to be understood in this context to mean an application whose application period covers at least 50%, preferably at least 70% and particularly preferably at least 90% of a total application period of the article. It is possible for the replacement certificate to be matched specifically to the requirements of the application upon issue and/or to be adapted during an operating time. In particular, additional services matched to the respective certificate, can be provided for particular applications, in particular main applications. Further, applications for which the article is not intended can be excluded from a scope of warranty of the replacement certificate.

Moreover, it is proposed that the sensing unit senses usage parameters and/or article parameters within at least one interval of time, in particular during a warranty time of the certificate and particularly preferably during a life of the article, in particular continuously, the computing unit using said parameters to adapt the issued certificate. It is advantageously possible to attain continuous adaptation of the certificate during a life of the article. As a further advantage, continuous monitoring of the article can be effected.

Further, it is proposed that to issue the certificate and/or for assignment the sensing unit senses at least one usage parameter configured at least as a usage time, a usage duration, a number of usages, a usage location, a usage intensity and/or a usage state of the article. It is advantageously possible to attain simple and in particular certificate-specific usage parameter sensing.

It is furthermore proposed that the computing unit assigns the article to the person on the basis of at least one identification parameter of the person, and at least initiates an allocation of usage rights for the person in the event of a repeated assignment by means of the same identification parameter. An “identification parameter” is in particular supposed to be understood to mean a characteristic value that characterizes a person and/or a user account already linked to the person, a further article, such as, for example, a wearable, a laptop, a smartphone, a tablet, a smartwatch or the like, and in particular an item of work clothing. In particular, the identification parameter may be an identification number assigned to the user, a PIN, a fingerprint, an iris image or the like. In particular, it is conceivable for the computing unit, in the event of a repeated assignment with the same identification parameter, to characterize the person as a main user and/or as a contact partner for management, maintenance, servicing and/or repair of the article and preferably to allocate main usage rights to said person. A “main user” is in particular supposed to be understood to mean a person who uses the article at least 50%, preferably at least 70% and particularly preferably at least 90% of a total time of use of the article. It is advantageously possible for assignment to a person to be improved and, in particular, made particularly secure. As a further advantage, security can be improved, since in particular only identified persons are authorized to use the article. Further, it is conceivable for a certificate for an assignment to a person to comprise the identification parameter.

It is also proposed that the apparatus has at least one, in particular wireless, communication unit that, to issue the at least one certificate and/or in particular to assign the article to a person, transmits the at least one usage parameter and/or the at least one article parameter to at least one external unit, which may in particular comprise the computing unit. A “communication unit” is in particular supposed to be understood to mean a unit that is intended at least for electronic, preferably wireless, information transmission. The communication unit is in particular intended for authorized and/or encrypted information transmission that is in particular dependent on the at least one authorization parameter and/or the at least one encryption parameter of the certificate. In particular, the communication unit is intended for information transmission by radio, such as, for example, via W-LAN, Bluetooth, near-field communication, transponder, such as, for example, by means of an RFID chip, wireless networks with little data traffic, such as in particular ZigBee, by means of data transfer protocols, such as in particular ANT+, LoRa, NBloT, or the like, and/or for optical information transmission, such as, by way of example, infrared. The communication unit may in particular be part of the article and/or the external unit. It is conceivable for the communication unit to be part of a mobile unit, such as, for example, a wearable, a laptop, a smartphone, a tablet, a smartwatch or the like, and/or of work clothing. Preferably, the apparatus has at least one transmission and/or reception unit for transmitting electronic data. The apparatus preferably has at least two transmission and/or reception units or information units, in particular at least one NFC transmission and/or reception unit and a Bluetooth transmission and/or reception unit. Alternatively or additionally, the apparatus comprises at least one or more information unit(s), such as, for example, a QR code, a data matrix code or the like. Preferably, at least one of the at least two transmission and/or reception units, in particular an NFC transmission and/or reception unit, is intended for fast connection setup between the apparatus and an external unit, in particular the hand-held machine tool. Preferably, at least one of the at least two transmission and/or reception units, in particular a Bluetooth transmission and/or reception unit, is intended for data transmission, in particular for transmission of a multiplicity of data in a short period of time, between the apparatus and an external unit, in particular of the hand-held machine tool. It is advantageously possible to achieve flexible transmission of usage parameters and/or article parameters for issuing the certificate.

It is further proposed that the apparatus has an, in particular wireless, communication unit that transmits an issued certificate and/or in particular the assignment of the article to the person to at least one external unit. It is advantageously possible for the certificate to be issued within the article. Preferably, a computation complexity of the external unit can be reduced. Also, provision of the certificate can be simplified.

The apparatus according to the disclosure is not supposed to be limited to the application and embodiment described above in this case. In particular, the apparatus according to the disclosure can fulfill a manner of operation described herein by having a different number of individual elements, components and units than the number cited herein. Moreover, in the case of the value ranges indicated in this disclosure, values lying within the cited limits are also supposed to be deemed as disclosed and arbitrarily usable.

### BRIEF DESCRIPTION OF THE DRAWINGS

Further advantages are evident from the following description of the drawing. The drawing depicts an exemplary embodiment of the disclosure. The drawing, the description and the claims contain numerous features in combination. A person skilled in the art will expediently also consider the features individually and combine them to produce useful further combinations.

In the drawing:

FIG. 1 shows an apparatus for generating an identifier in a schematic view,

FIG. 2 shows a schematic flow for generation of an identifier performed by a computing unit of the apparatus,

FIG. 3 shows a further schematic flow for generation of an identifier performed by the computing unit, and

FIG. 4 shows a schematic view of certificates issued over the course of a life.

### DETAILED DESCRIPTION

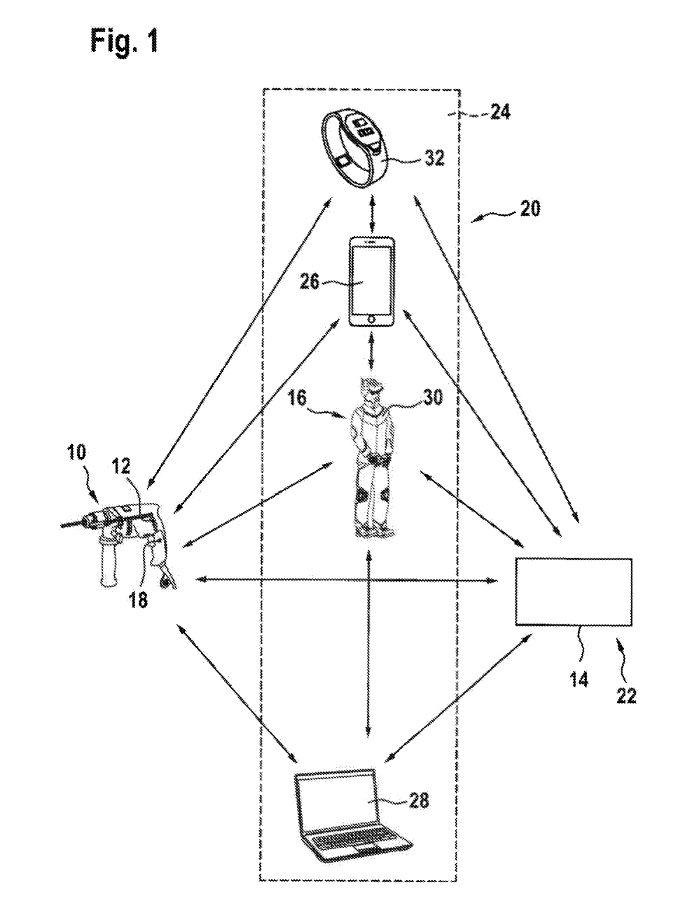

FIG. 1 depicts a schematic depiction of an apparatus for generating at least one identifier of at least one article 10. At least part of the apparatus is part of the article 10. In the present case, the article 10 is configured as a hand-held machine tool, in fact in particular as a hammer drill. Alternatively or additionally, the article 10 may also be configured as any article 10 that appears advantageous to a person skilled in the art, such as, for example, as an orbital sander, a garden machine tool or the like. Further, the system can have a different number of articles 10 than the number depicted here, which articles may in particular be configured to be different than one another. In particular, a number of articles 10 can form a stock of articles that the apparatus is intended to manage. The apparatus is then also intended to generate identifiers of the respective number of articles 10.

The apparatus comprises a memory unit 18. In the present case, the memory unit 18 is part of the article 10. The memory unit 18 is an internal memory unit 18 of the article 10. Alternatively, the memory unit 18 may also be part of an external unit 22.

The memory unit 18 stores at least one distribution parameter. In the present case, the distribution parameter is a purchase time, in particular a purchase date. Further, the memory unit 18 could store further distribution parameters, such as, for example, a sale location, a sale identification number or the like. Further, the memory unit 18 stores at least one production parameter of the article 10. The production parameter is a serial number. Further, the memory unit 18 stores at least one further production parameter. The further production parameter is a production date. Further, the memory unit 18 can be used to store an issued certificate. The certificate is stored by means of an authorization parameter assigned to the certificate. The authorization parameter allocates at least one access and/or machining right for the certificate and/or for at least one parameter from parameters that are combined in the certificate.

The apparatus comprises at least one sensing unit 12. In the present case, the sensing unit 12 is part of the article 10. The sensing unit 12 is an internal sensing unit 12 of the article 10. Alternatively, the sensing unit 12 may also be part of an external unit 22. The sensing unit 12 is intended to sense at least one usage parameter of the article 10. Further, the sensing unit 12 is intended to sense a further usage parameter. The usage parameter is stored in the memory unit 18. In the present case, the usage parameter is a usage time. The further usage parameter is stored in the memory unit 18.

The further usage parameter is a usage duration. Alternatively or additionally, the usage parameter sensed and/or stored in the memory unit 18 may also be a usage location, a usage intensity and/or a usage state of the article 10. Further, the memory unit 18 stores a usage limit value. The usage limit value is intended for comparison with the usage parameter.

The apparatus is part of an external unit 22. In the present case, the external unit 22 is configured as a server. Alternatively or additionally, the external unit 22 may be a computer network, a company headquarters and/or a cloud.

The system comprises at least one computing unit 14. In the present case, the computing unit 14 is part of the article 10. Alternatively, the computing unit 14 may also be part of the external unit 22. The computing unit 14 is intended to issue a certificate for the article 10. The computing unit 14 issues the certificate on the basis of the at least the usage parameter and in particular the further usage parameter. The computing unit 14 is in particular intended to use the usage parameter and in particular the further usage parameter to determine a time of first operation. The time of first operation is a usage time at which a usage duration exceeds a prescribed usage limit value. Alternatively or additionally, the computing unit 14 is intended to assign the article 10 to at least one person 16.

Further, the apparatus comprises at least one communication unit 20. The communication unit 20 is configured as a wireless communication unit 20. The communication unit 20 connects the sensing unit 12 and/or the memory unit 18 to the external unit 22. The communication unit 20 is intended to transmit at least the usage parameter, in particular between the article 10 and the external unit 22. Further, the communication unit 20 is intended to transmit the distribution parameters and/or the production parameters. The communication unit 20 is intended for encrypted transmission. The communication unit 20 encrypts the certificate and/or the parameters combined for issuing the certificate and/or in the certificate using at least one encryption parameter assigned to the certificate. Alternatively or additionally, the communication unit 20 may be intended to transmit the issued certificate. In the present case, the communication unit 20 is at least part of a mobile unit 24. The mobile unit 24 is assigned to a person 16 who uses the article 10. The mobile unit 24 is preferably formed by a smartphone 26. Further, the mobile unit 24 may be formed by a laptop 28, a network, in particular a W-LAN network, by an item of work clothing and/or a smartwatch 32. Alternatively, it is also conceivable for the communication unit 20 to be part of the article 10 and/or of the external unit 22.

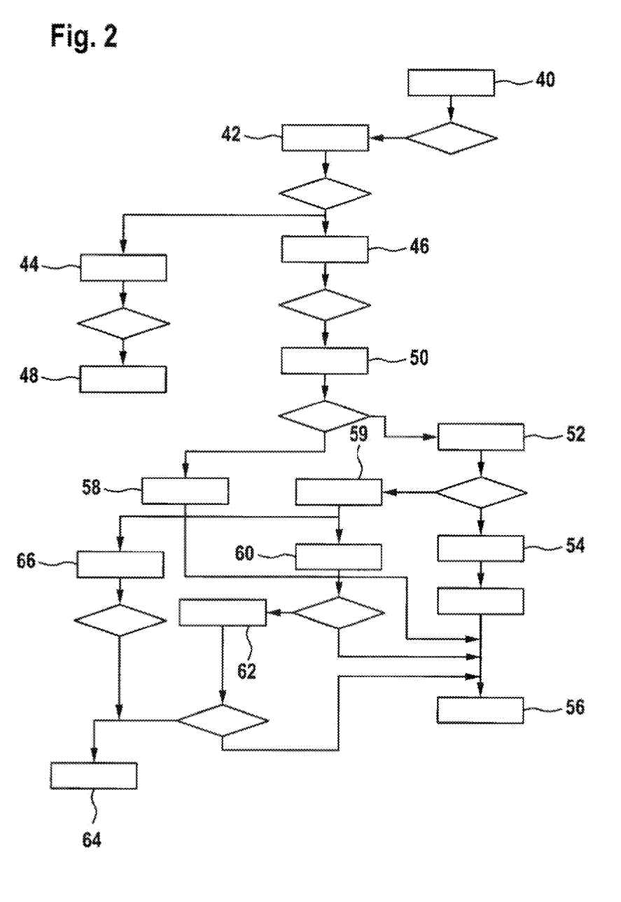

FIG. 2 schematically depicts generation of an identifier performed by the computing unit 14 of the apparatus. Further, the generation comprises issuing at least one certificate. In the present case, the certificate is a certificate of first operation. To perform the generation, the computing unit executes a step sequence.

The step sequence comprises at least one step 40. In the step 40, the communication unit 20 connects the article 10 to the external unit 22. The computing unit 14 registers the article 10 in a stock of articles. The external unit 22 reads the parameters stored in the memory unit 18, in particular the usage parameter, the distribution parameter, the further distribution parameter, the production parameter and/or the further production parameter. The computing unit 14 compares whether at least one of the parameters, in particular the production parameter, in fact the serial number of the article 10, is already stored. Alternatively or additionally, the sensing unit 12 can comprise and/or allow a manual input means and/or image capture of the production parameters. If the article 10, in fact in particular with the associated production parameter, is present in the stock of articles, the computing unit 14 concludes the process. Alternatively, the sensing unit 12 can, in particular for an already registered article 10, sense usage parameters, in particular continuously, within at least one interval of time, said usage parameters being processed by the computing unit 14 to adapt an issued certificate.

The step sequence comprises a further step 42. The computing unit 14 executes step 42 if the production parameters, distribution parameters, usage parameters and/or the associated article 10 are not yet stored and/or registered in the external unit 22. In step 42, the computing unit 14 queries whether the article 10 is already assigned to the person 16. Alternatively, it is also possible to query whether the article 10 is assigned to a user, an owner, a main user and/or a company.

The step sequence comprises a further step 44. The computing unit 14 performs step 44 if the article 10 is not yet assigned to the person 16. The computing unit 14 makes an assignment in step 44. Further, the computing unit 14 queries whether the article 10 is already assigned by means of its production parameter to a further person 16, a further user, a further owner, a further main user and/or a further company.

The step sequence comprises a further step 48. The computing unit 14 assigns the article 10 if the article 10 is not yet assigned to a further person 16 by means of its production parameter.

The step sequence comprises a further step 46. In step 46, the computing unit 14 queries whether a certificate is supposed to be issued for the article 10.

The step sequence comprises a further step 50. The computing unit 14 performs step 50 if a certificate is supposed to be issued. The computing unit 14 issues the certificate for the article 10, at least on the basis of the at least one sensed usage parameter. Further, the computing unit 14 uses the at least one usage parameter to ascertain at least one application, in particular a main application, of the article 10 and issues the certificate on the basis thereof. Further, the computing unit 14 at least uses the at least one usage parameter, in fact in particular the usage time, and the further usage parameter, in fact in particular the usage duration, to ascertain a time of first operation of the article 10. If the further usage parameter exceeds a limit value during a usage of the article 10, for example, then the computing unit 14 assumes the usage parameter at the time of the exceedance as the time of first operation. The computing unit 14 further takes the time of first operation as a basis for issuing the certificate or matches the latter to the time of first operation. Further, the computing unit 14 determines an age of the article 10. To this end, the computing unit 14 uses at least the distribution parameter and/or production parameter stored in the memory unit 18 to verify the ascertained time of first operation. The computing unit 14 determines the age from the difference between the time of first operation and the further production parameter. By way of example, the computing unit 14 can output an error if a time of first operation is before a purchase time of the distribution parameter.

The step sequence comprises a further step 52. The computing unit 14 performs the further method step 52 if the time of first operation differs from the purchase time by more than five hours. Further, the computing unit 14 queries a further distribution parameter, in fact in particular a purchase time, in step 52. The computing unit 14 queries whether a proof of purchase is available.

The step sequence comprises a further step 54. The computing unit 14 performs step 54 if the proof of purchase is available. Alternatively, it is conceivable for there to be no proof of purchase available or for said proof of purchase to have been lost, so that the certificate issued by the computing unit 14 replaces the proof of purchase in this case. In step 54, the sensing unit 12 reads in the proof of purchase. To this end, the sensing unit 12 reads the further distribution parameter from the proof of purchase.

The step sequence comprises a further step 56. In step 56, the communication unit 20 transmits the sensed parameters to the external unit 22. The computing unit 14 concludes a registration of the article 10 in the stock of articles by issuing a replacement certificate for the article 10 and/or in particular assigning the article 10 to the person 16. In the present case, the computing unit 14 uses the issued replacement certificate to occur replace a proof of purchase for the article 10.

The step sequence comprises a further step 58. In step 58, the computing unit 14 sets the time of first operation equal to the purchase time if the time of first operation differs from the purchase time by less than five hours. After step 58, the computing unit 12 executes step 56.

The step sequence comprises a further step 59. The computing unit 14 performs method step 59 if there is no proof of purchase available. The computing unit 14 initiates the purchase time being able to be input by the person 16.

The step sequence comprises a further step 60. The computing unit 14 verifies the input purchase time by means of the state of first operation. If the input purchase time is substantially concordant with the time of first operation, the computing unit 14 executes step 56.

The step sequence comprises a further step 62. The computing unit 14 performs step 62 if the indicated purchase time is substantially different than the time of first operation, in fact in particular by more than five hours. The computing unit 14 proposes the time of first operation as a purchase time. The person 16 can accept the time of first operation as the purchase time. If the time of first operation is accepted as the purchase time, the computing unit 14 continues with step 56.

The step sequence comprises a further step 64. The computing unit 14 performs step 64 if the proposal to adopt the time of first operation as the purchase time is not accepted. In step 64, the computing unit 14 outputs that the article 10 is not registrable. Further, the computing unit 14 can alternatively or additionally set up a connection to a service center.

The step sequence comprises a further step 66. The computing unit 14 performs step 66 after method step 58, in particular as an alternative to step 60. In step 66, the computing unit 14 verifies the purchase time using the production parameter, in particular the serial number. By way of example, the computing unit 14 detects an error if the serial number had not yet been allocated at the indicated purchase time, for example. The computing unit 14 continues with step 64.

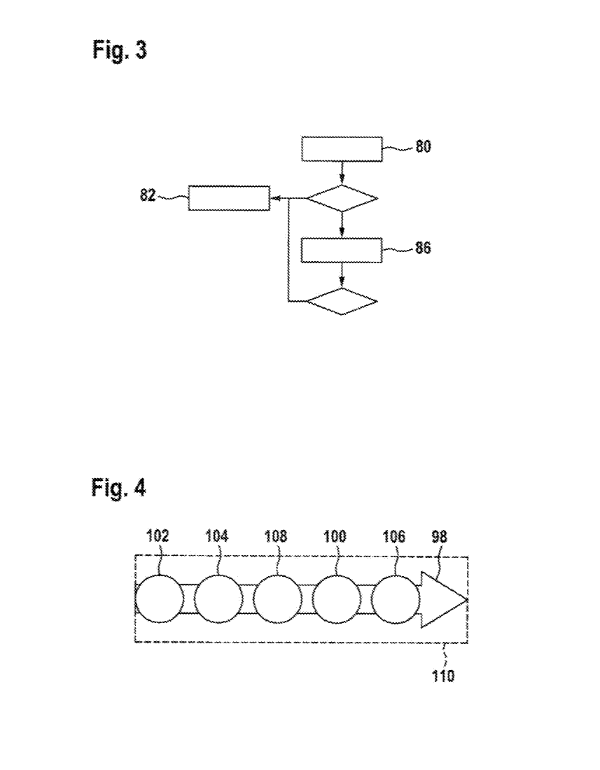

FIG. 3 shows further steps in the step sequence.

The step sequence comprises a further step 80. The computing unit 14 registers the article 10 in a stock of articles in step 80. The communication unit 20 connects the article 10 to the external unit 22. The parameters stored in the memory unit 18, in particular the usage parameter, the distribution parameter, the further distribution parameter, the production parameter and/or the further production parameter, are read by the computing unit 14. Further, the computing unit 14 assigns the article 10 to the person 16 on the basis of at least one identification parameter of the person 16. The computing unit 14 compares whether a main user is already stored for the article 10.

The step sequence comprises a further step 82. If a main user is already stored, the computing unit executes step 82. In step 82, the computing unit 14 queries whether a central contact partner for management, maintenance, servicing and/or repair is already stored. If a contact partner is not yet stored, the computing unit 14 stores the assigned person 16 as a contact partner.

The step sequence comprises a further step 86. If there is a main user, the computing unit 14 stores the main user as a contact partner in step 86. By way of example, the computing unit 14 can detect a repeated assignment of a person 16 and can thus store the person 16 as main user. To this end, the computing unit 14, in the event of a repeated assignment by means of the same identification parameter, initiates at least one allocation of usage rights for the person 16.

As depicted by way of example in FIGS. 2 and 3, the computing unit 14 combines different parameters to produce a certificate. FIG. 4 depicts a timeline for issuance of various certificates over a life 98 of the article. The issuance of the certificate from FIG. 2 over the course of a life of the article 10 is explained by way of example below. Further, the issuance of further certificates is explained using further examples below.

In the present case, the certificate 100 is configured as a certificate of first operation. The computing unit 14 issues the certificate 100 at least using the usage parameter. The usage parameter is a usage time. Further, the computing unit 14 issues the certificate 100 at least using the further usage parameter. The further usage parameter is a usage duration. The usage parameter and the further usage parameter are used by the computing unit 14 to determine the time of first operation. The time of first operation is a usage time at which a usage duration exceeds a prescribed usage duration limit value. Alternatively, the computing unit 14 can ascertain the time of first operation using a usage routine, such as a key combination, for example.

Alternatively or additionally, the computing unit 14 can issue at least one first further certificate 102. In the present case, the computing unit 14 issues at least one first further certificate 102. The first further certificate 102 is configured as a production certificate. The computing unit 14 issues the first further certificate 102 at least using an appliance parameter. The appliance parameter is a production parameter, in fact in particular a production time, such as, for example, a date and/or a time of day on/at which the article is produced and in particular finished. Further, the computing unit 14 issues the first further certificate 102 comprising at least one further article parameter. The further article parameter is a production parameter in the present case, in fact in particular a serial number and/or a bare tool number of the article.

Alternatively or additionally, the computing unit 14 can issue at least one second further certificate 104. In the present case, the computing unit 14 issues a second further certificate 104. The second further certificate 104 is configured as a test certificate. The computing unit issues the second further certificate 104 at least using a first further usage parameter. The first further usage parameter is a usage intensity, such as a maximum rotation speed, for example. Further, the computing unit 14 issues the second further certificate 104 at least using a second further usage parameter. The second further usage parameter is a test time, such as a date and/or a time of day on/at which a test is performed and in particular on/at which the sensing unit 14 senses the second further usage parameter, for example.

Alternatively or additionally, the computing unit 14 can issue at least one third further certificate 106. In the present case, the computing unit 14 issues a third further certificate 106. The third further certificate 106 is configured as a maintenance certificate. The computing unit 14 issues the third further certificate 106 at least using a first further article parameter, in particular a maintenance parameter. The first further article parameter is a maintenance time. Further, the computing unit issues the third further certificate 106 using a second further article parameter, in particular a maintenance parameter, in fact in particular using an indication of a component to be maintained in the article 10. It is conceivable for the computing unit to combine the third further certificate 106 and the second further certificate 104 to produce a main certificate, such as an operation certificate, for example.

Alternatively or additionally, the computing unit 14 can issue at least one fourth further certificate 108. In the present case, the computing unit 14 issues a fourth further certificate 108. The fourth further certificate 108 is configured as a distribution certificate. The computing unit 14 issues the fourth further certificate 108 at least using a third further article parameter. The third further article parameter is a distribution parameter, such as in particular a piece of purchaser information. Further, the computing unit 14 issues the fourth further certificate 108 using a fourth further article parameter, in particular a maintenance parameter, in fact in particular using a purchase time for the article 10.

It is conceivable for the computing unit 14 to combine multiple, in particular all, certificates to produce a main certificate 110, such as in particular a timeline and/or life certificate, for example. The main certificate 110 can comprise all certificates issued in a timeline for the article, preferably over the course of a life of the article.

What is claimed is:

1. An apparatus for generating at least one identifier of at least one article comprising:
at least one sensing unit configured to sense at least one usage parameter and/or at least one article parameter of the at least one article; and
at least one computing unit configured to take the sensed at least one usage parameter and/or the sensed at least one article parameter as a basis for issuing a certificate for the at least one article.

2. The apparatus according to claim 1, wherein the computing unit is configured to use at least the sensed at least one usage parameter to ascertain at least one time of first operation of the at least one article and to issue the certificate on the basis thereof.

3. The apparatus according to claim 2, wherein the computing unit is configured to use at least one distribution parameter stored in a memory unit to verify the ascertained at least one time of first operation.

4. The apparatus according to claim 2, wherein the computing unit is configured to use the sensed at least one distribution parameter and the ascertained at least one time of first operation to compute an age of the at least one article and to issue the certificate on the basis thereof.

5. The apparatus according to claim 1, wherein the computing unit is configured to use the sensed at least one usage parameter and/or the sensed at least one article parameter to ascertain at least one application of the at least one article and to issue the certificate on the basis thereof.

6. The apparatus according to claim 1, wherein:
the at least one sensing unit is further configured to sense the at least one usage parameter and/or the at least one article parameter within at least one interval of time, and
the computing unit is further configured to process the sensed at least one usage parameter and/or the sensed at least one article parameter in order to adapt the issued certificate.

7. The apparatus according to claim 1, wherein, to issue the certificate, the at least one sensing unit is configured to sense at least one usage parameter configured at least as a usage time, a usage duration, a number of usages, a usage location, a usage intensity, and/or a usage state of the at least one article.

8. The apparatus according to claim 1, further comprising:
at least one communication unit that, to issue the certificate, is configured to transmit the sensed at least one usage parameter and/or the sensed at least one article parameter to at least one external unit.

9. The apparatus according to claim 1, further comprising:
at least one communication unit configured to transmit the issued certificate to at least one external unit.

10. A machine tool comprising:
at least one apparatus configured to generate at least one identifier of at least one article, the at least apparatus including
at least one sensing unit configured to sense at least one usage parameter and/or at least one article parameter of the at least one article, and
at least one computing unit configured to take the sensed at least one usage parameter and/or the sensed at least one article parameter as a basis for issuing a certificate for the at least one article.
